(19) United States
(12) Patent Application Publication
(10) Pub. No.: US 2023/0091400 A1
(43) Pub. Date: Mar. 23, 2023

(54) Hydraulically Amplified Self-Healing Electrostatic (HASEL) Actuator Systems for Gripping Applications

(71) Applicant: Artimus Robotics, Boulder, CO (US)

(72) Inventors: Eric Lucas Acome, Longmont, CO (US); Nicholas Alexander Kellaris, Boulder, CO (US); Shane Karl Mitchell, Boulder, CO (US); Timothy G. Morrissey, Boulder, CO (US)

(73) Assignee: Artimus Robotics, Boulder, CO (US)

(21) Appl. No.: 17/948,066

(22) Filed: Sep. 19, 2022

Related U.S. Application Data
(60) Provisional application No. 63/245,336, filed on Sep. 17, 2021.

(51) Int. Cl. B25J 15/00; B25J 15/12

(52) U.S. Cl. CPC B25J 15/0023; B25J 15/12; B25J 15/0033

(57) ABSTRACT

Systems and methods for grasping and manipulating objects are presented. The systems include a first actuator configured to either contract, expand, or rotate about a first axis. In some cases the actuator acts to deform a structure that is configured to grasp an object. In other cases the actuator directly interacts with an object to grasp the object or aid in the grasping of the object. The entire system may be connected to a robotic arm or other system to allow for picking and placing of objects. The first actuator includes a compliant shell defining an enclosed cavity, a dielectric fluid disposed within the enclosed cavity, a first electrode disposed on a first side of the compliant shell, and a second electrode disposed on a second side of the compliant shell opposite the first side.

### CROSS REFERENCE TO RELATED APPLICATIONS

The present application claims the benefit of U.S. Provisional Patent Application No. 63/245,336, filed Sep. 17, 2021, and entitled “HYDRAULICALLY AMPLIFIED SELF-HEALING ELECTROSTATIC (HASEL) ACTUATOR SYSTEMS FOR GRIPPING APPLICATIONS.” Further, this disclosure relates to PCT Publication No. WO 2018/175741 entitled “HYDRAULICALLY AMPLIFIED SELF-HEALING ELECTROSTATIC TRANSDUCERS” filed on Mar. 22, 2018; PCT Application No. PCT/US2019/020568 entitled “HYDRAULICALLY AMPLIFIED SELF-HEALING ELECTROSTATIC TRANSDUCERS HARNESSING ZIPPING MECHANISM” filed on Mar. 4, 2019; PCT Application No. PCT/US20/20986 entitled “FOLDABLE FILLING FABRICATION AND COMPOSITE LAYERING OF HYDRAULICALLY AMPLIFIED SELF-HEALING ELECTROSTATIC TRANSDUCERS” filed on Mar. 4, 2020; PCT Application No. PCT/US20/20978 entitled “COMPOSITE LAYERING OF HYDRAULICALLY AMPLIFIED SELF-HEALING ELECTROSTATIC TRANSDUCERS” filed on Mar. 4, 2020; and U.S. Provisional Patent App. 63/032,209 entitled “CAPACITIVE SELF-SENSING FOR ELECTROSTATIC TRANSDUCERS WITH HIGH VOLTAGE ISOLATION” filed on May 29, 2020, the entirety of each of the foregoing incorporated by reference herein.

### SUMMARY OF THE DISCLOSURE

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its purpose is to present some concepts of one or more aspects in a simplified form as a prelude to the more detailed description that is presented later.

Systems for grasping and manipulating objects are presented. The systems include a first actuator configured to either contract, expand, or rotate about a first axis. In some cases the actuator acts to deform a structure that is configured to grasp an object. In other cases the actuator directly interacts with an object to grasp the object or aid in the grasping of the object. The entire system may be connected to a robotic arm or other system to allow for picking and placing of objects. The first actuator includes a compliant shell defining an enclosed cavity, a dielectric fluid disposed within the enclosed cavity, a first electrode disposed on a first side of the compliant shell, and a second electrode disposed on a second side of the compliant shell opposite the first side.

### BRIEF DESCRIPTION OF THE DRAWINGS

The appended drawings illustrate only some implementation and are therefore not to be considered limiting of scope.

FIGS. 1A-1C illustrate a simplified cross section of a Hydraulically-Amplified Self-Healing Electrostatic (HASEL) actuator at increasing voltage levels, in accordance with an embodiment.

FIG. 2 illustrates a cross-sectional view of a “contracting” HASEL actuator at increasing voltage levels, in accordance with an embodiment.

FIGS. 3A and 3B illustrate a cross-sectional view of a “expanding” HASEL actuator at increasing voltage levels, in accordance with an embodiment.

FIGS. 4A and 4B illustrate a cross-sectional view of a system of HASEL actuators joined together to amplify performance, in accordance with an embodiment.

FIGS. 5A and 5B illustrate a “bending” HASEL actuator without and with an applied voltage.

FIGS. 6A-6D illustrate an actuator having a plurality of distinct electrodes configured to selectively receive voltage and interact with portions of a flexible electrode to form at least one pocket of dielectric fluid, in accordance with an embodiment.

FIGS. 7A-7D illustrate the capacitance of a HASEL actuator at various voltages, in accordance with an embodiment.

FIGS. 8A and 8B illustrate the changing capacitance of a HASEL actuator at a fixed voltage in response to an external force, in accordance with an embodiment.

FIGS. 9A and 9B illustrate the changing capacitance of a HASEL actuator due to a changing voltage, changing force, or both, in accordance with an embodiment.

FIG. 10 illustrates a system for gripping objects that includes contracting HASEL actuators that pull on tendons of a finger-like structure, in accordance with an embodiment.

FIG. 11 illustrates a system for gripping objects that includes bending HASEL actuators that directly grasp objects, in accordance with an embodiment.

FIGS. 12A-12C illustrate a system where expanding HASEL actuators are mounted on the jaws of a parallel jaw mechanism and are configured to directly contact objects, in accordance with an embodiment.

FIG. 13 illustrates a system for gripping objects that includes a lever arm that is moved by a HASEL actuator, in accordance with an embodiment.

FIGS. 14A-14D illustrate a system for picking up objects using a HASEL actuator with a plurality of distinct electrodes configured to form a moving pocket of liquid dielectric, in accordance with an embodiment.

FIGS. 15A-15C illustrate a system for active rotation in two directions by utilizing an antagonist pair, each including a HASEL actuator, electrostatic clutch, and spring, in accordance with an embodiment.

FIGS. 16A and 16B illustrate a system for rotation in two directions by utilizing an antagonist pair where one side includes a spring element and the other side includes a HASEL actuator, in accordance with an embodiment.

FIGS. 17A and 17B illustrate a system for gripping objects using antagonist pairs, in accordance with an embodiment.

FIG. 18 illustrates a flow diagram for grasping an object and sensing the grip based on the capacitance of a HASEL actuator, in accordance with an embodiment.

FIG. 19 illustrates a flow diagram for using a HASEL actuator as a sensor on the jaws of a gripper, in accordance with an embodiment.

FIG. 20 illustrates a flow diagram for using a HASEL actuator to detect change in grip of an object based on capacitance and to adjust the grip accordingly, in accordance with an embodiment.

FIG. 21 illustrates a flow diagram for using a HASEL actuator to estimate the size of an object, in accordance with an embodiment.

FIGS. 22A-22D illustrate a system for using a HASEL actuator to estimate the elastic modulus of an object, in accordance with an embodiment.

### DETAILED DESCRIPTION

The present invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath,” “below,” “lower,” “under,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” or “under” other elements or features. Thus, the exemplary terms “below” and “under” can encompass both an orientation of above and below. The device may be otherwise oriented (rotated 90 degrees or at other orientations) and the spatially relative descriptors used herein interpreted accordingly. In addition, it will also be understood that when a layer is referred to as “between” two layers, it can be the only layer between the two layers, or one or more intervening layers may also be present.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items, and may be abbreviated as “/”.

It will be understood that when an element or layer is referred to as being “on,” “connected to,” “coupled to,” or “adjacent to” another element or layer, it can be directly on, connected, coupled, or adjacent to the other element or layer, or intervening elements or layers may be present. In contrast, when an element is referred to as being “directly on,” “directly connected to,” “directly coupled to,” or “immediately adjacent to” another element or layer, there are no intervening elements or layers present. Likewise, when light is received or provided “from” one element, it can be received or provided directly from that element or from an intervening element. On the other hand, when light is received or provided “directly from” one element, there are no intervening elements present.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing. Accordingly, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

Grippers are critical components of robotic systems. Typically mounted to the end of a robotic arm, a gripper is the part of a robot that directly interacts with an object while the robot performs a task. Common applications robots with grippers include picking objects up from one place and moving them to another. For example, picking an assortment of objects from a bin and placing them onto a conveyor or sorting them into new bins. The task of gripping objects can be very complicated and is often specific to the object that will be grasped. Currently, common types of grippers include rigid jaw grippers, soft grippers often powered by pneumatics, and suction cups that are used to grasp objects.

Rigid jaw grippers are made from rigid materials and driven by motors or pneumatic cylinders. These rigid grippers must be specifically designed to grasp a given object to ensure a sufficient grip and to prevent damage to the object. These work well for parts made from metal or stiff plastic and that have a consistent size and shape. However, such rigid grippers are not sufficient for gripping objects that vary in size and shape or objects that are made from compliant or fragile materials.

Soft grippers powered by pneumatics or air pressure, can pick up a variety of objects. While the soft material inherently conforms to different objects when inflated, these soft grippers generally do not provide feedback regarding grip force, quality, size, or other attributes of the object being grasped. Additionally, pneumatic systems are not always feasible or desirable.

Suction cup grippers can pick up a variety of objects as long as the objects have a surface that is relatively flat and large enough for the size of the suction cup. Objects that are small, have high curvature surfaces, or are porous can be difficult if not impossible for suction cup grippers. Additionally, suction cup grippers must be tethered to a pneumatic compressor that provides negative pressure. Pneumatic lines running to the suction cups can limit range of motion for the robot. Furthermore, operating cost for pneumatic systems is high.

Here we describe new grippers and systems that utilize Hydraulically-Amplified Self-Healing Electrostatic (HASEL) actuators. HASEL actuators provide benefits such as direct electrical control which provides very fast response times and eliminates the need for a connection to compressed air. The inherent compliance of HASEL actuators, allows them to easily conform to a variety of object shapes and sizes, therefore providing a quality grip without risk of damaging delicate objects. HASEL actuators also provide variable force or displacement for better control of the grip and to allow for grip adjustments in real-time. Finally, the capacitance of a HASEL actuator can be monitored during actuation to track quality of the grip and detect slip or to infer information about the gripped object, such as size, shape, or modulus.

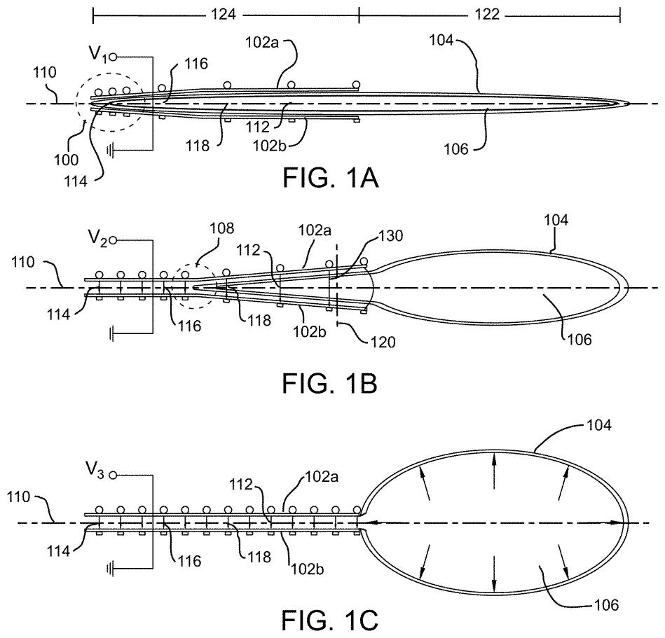

FIGS. 1A-1C show an exemplary structure of a HASEL actuator. A flexible shell or pouch 104 (e.g., inextensible and/or elastically deformable) defines an enclosed internal cavity designed with one or more tapered boundaries and that is filled with a liquid dielectric 106. A first electrode 102a is disposed over a first side of the enclosed internal cavity and a second electrode 102b is disposed over a second side of the enclosed internal cavity opposite the first side. The electrodes 102a, 102b are placed on opposing sides of a tapered boundary of the shell 104, extending to or almost to the end of the tapered boundary.

In some embodiments, an edge of each of the electrodes 102a, 102b is flush or nearly flush with an edge of the enclosed internal cavity containing the liquid dielectric 106. This geometry forms a zipping initiation site 100 wherein the opposing electrodes 102a, 102b are in close proximity to one another, whereas the electrodes 102a, 102b are separated by a greater distance toward the opposite end of the electrodes. For example, as shown in FIG. 1A, at first reference point 112 along reference axis 110, electrodes 102a and 102b are separated by a greater distance than at second reference point 114 which is disposed nearer a peripheral edge of the shell 104 than the first reference point. However, in some embodiments, the first reference point (where the distance between electrodes is greater) may be disposed nearer the peripheral edge.

FIG. 1A illustrates the actuator at rest moments before or simultaneous with application of voltage V₁. In this state, the electric field generated by the relatively low voltage is concentrated at the edge of the tapered boundary where the electrodes 102a, 102b are closest together. This concentration of the electric field at the edge causes the tapered region to experience a high electrostatic stress in comparison to the rest of the shell 104, and in response, the electrodes 102a, 102b move closer together.

As shown in FIG. 1B, as voltage is increased to V₂, the electrostatic forces 130 extend further in a direction parallel to reference axis 120, causing a larger portion of the electrodes 102a, 102b to be drawn together as the voltage overcomes the larger distances between the electrodes through the liquid dielectric 106. The drawing together of the electrodes forces the top and bottom layers of the shell to be brought together in opposing directions parallel to reference axis 120 by the electrodes and forces the liquid dielectric 106 into the inactive area 122 of the shell 104 from the progressive zipping site 108, which moves progressively to the right in the figure, through the active area 124 as the voltage is increased further. It should be appreciated that in the case of a strain limiting layer, or when one side of the shell is otherwise fixed in position to another object (e.g., another actuator or a solid surface), that one side may remain stationary and relative movement between the top and bottom layers of the shell may be only with respect to the side which is not fixed.

Notably, the length of the portion of electrodes 102a, 102b which are fully drawn together can be controlled along a continuum from zero to the full length of the electrodes based on how much voltage is supplied. This effect provides a high degree of control over the extent to which the actuator is actuated as compared to binary or “on/off” actuators.

Upon full actuation caused by voltage V₃, shown in FIG. 1C, substantially all of the liquid dielectric 106 is forced into the inactive region of shell 104. In this state, electrodes 102a, 102b are fully drawn together, pinching the active portion of shell 104. In this fully actuated state, the distance between the electrodes 102a, 102b is constant along reference axis 110 from first reference point 112 to second reference point 114.

In the intermediate state shown in FIG. 1B, voltage V₂ is sufficient to draw the electrodes 102a, 102b together between second reference point 114 and third reference point 116. However, voltage V₂ may be insufficient to overcome the increased pressure in shell 104 (as compared to the resting state shown in FIG. 1A) and close the gap between third reference point 116 and fourth reference point 118. Increasing the voltage to V₃ may overcome the increased pressure and draw the entirety of electrodes 102a, 102b together as shown in FIG. 1C. It should be noted that embodiments using an inextensible shell 104 would experience a contraction in a direction along reference axis 110 in response to the vertical flexing of the shell 104 caused by the increased pressure. In the embodiment illustrated in FIGS. 1A-1C, the shell 104 is elastically deformable.

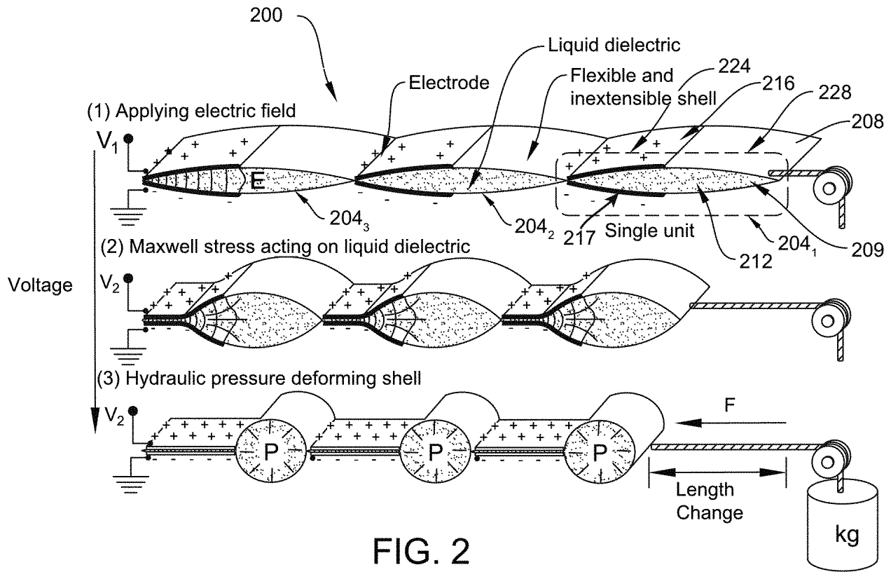

FIG. 2 shows a category of contracting HASEL actuators or peano-type actuators. Contracting HASEL actuators are capable of fast, muscle-mimetic, linear contraction upon activation. This mode of actuation can exploit certain geometric principles free of relying on stacks of actuators, initial pre-stretching, rigid components, or other techniques. As illustrated in FIG. 2, the structure of a peano-type actuator 200 can include a flexible, but inextensible shell 208 segmented into discrete pouches 209 that are each filled with a liquid dielectric 212. In other words, the internal cavity may be segmented into a plurality of sub-cavities. Each pouch 209 may not be in fluid communication with any of the other pouches 209. F₁ rst and second electrodes 216, 217 may be disposed over the shell 208 of each pouch 209. The electrodes 216, 217 can be compliant or rigid, depending on the application. The portion of each pouch 209 covered by the electrodes 216, 217 may be referred to as the active area 224 while the uncovered portion (where contractile geometry change occurs as discussed below) may be referred to as the inactive area 228. To limit electrical arcing through the air around the device during operation, a skirt or an insulating layer can be added to cover the electrodes 216, 217.

In any case, the combination of each respective pouch 209, liquid dielectric 212, first and second electrodes 216, 217 may be referred to as a unit 204 and the peano-type actuator 200 may have any appropriate number of interconnected units 204 (e.g., such as units 204₁, 204₂, 204₃). When an increasing voltage (V) is applied to the electrodes 216, 217 of the interconnected units 204, electrostatic forces displace the liquid dielectric 212 causing electrodes 216, 217 to progressively draw together and close; this forces fluid from the active areas 224 into the inactive areas 228 which causes a transition from a flat cross section to a more circular one and leads to a contractile force, F.

When voltage is applied to the electrodes 216, 217, they attract due to electrostatic forces. This attraction is governed by the Maxwell pressure:

ρ=ϵϵ₀Ε² [Eq. 1]

where Ε is the electric field between the electrodes, ϵ₀ is the permittivity of free space, and E is the relative permittivity of the dielectric between the electrodes. As the electrodes attract, they redistribute fluid from the active areas 224 into the inactive areas 228. Due to shell 208 being inextensible (i.e., non-elastic), each inactive area 228 is forced to transition from a flat cross-section to a more circular one as shown. This transition may result in a theoretical linear contraction of up to 1−2/π, or approximately 36%, in inactive areas 228. When a weight is attached to one end of actuator 200, the increase in fluid pressure is converted to mechanical work performed on the external load. FIG. 2 shows the conversion to mechanical force, as well as the accompanying deformation of the actuator pouches 209.

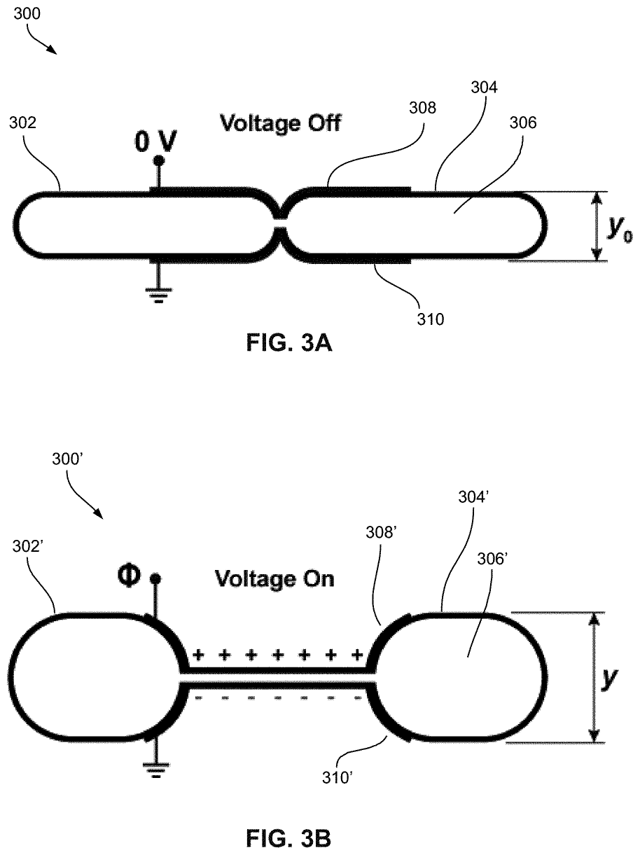

FIGS. 3A and 3B show a cross-section view of an embodiment of a HASEL actuator 300 which expands upon activation. This embodiment of the HASEL actuator includes one or more portions of a pouch, such as a first portion 302 and a second portion 304 made from dielectric film and filled with a fluid dielectric 306. Two electrodes 308, 310 are disposed on the outside of the dielectric film pouch. A first electrode 308 may be positioned substantially opposite the second electrode 310 as shown. FIG. 3A shows the actuator 300 in an off-state. In the off-state, no voltage is applied to the actuator and the electrodes generally conform to the resting shape of the pouch. FIG. 3B shows the actuator 300′ in an on-state. Voltage is applied to one of electrodes 308′,310′ causing the two electrodes to draw together. The electrodes draw together, or zip together, starting at the ends of the electrodes that are nearest each other and draw closer along the length. For example, on first portion 302′, the electrodes 308′,310′ zip together starting at a right side of the first portion and moving toward the left; on second portion 304′, the electrodes 308′,310′ zip together starting at a left side of the pouch and moving toward the right. As the electrodes pull together, dielectric fluid 306′ is displaced toward one side of the pouch causing the pouch to form a more circular or bulbous pocket at one end. The height of the actuated pouch is shown as y in FIG. 3B; on-state height y is greater than the off-state height, or initial height, y₀ shown in FIG. 3A. The on-state height y may be a function of a load F applied to the actuator (e.g., an external load that resists an increase in height y) and the applied voltage. These factors may determine the length that the electrodes that zip together, and correspondingly, how much dielectric fluid is displaced.

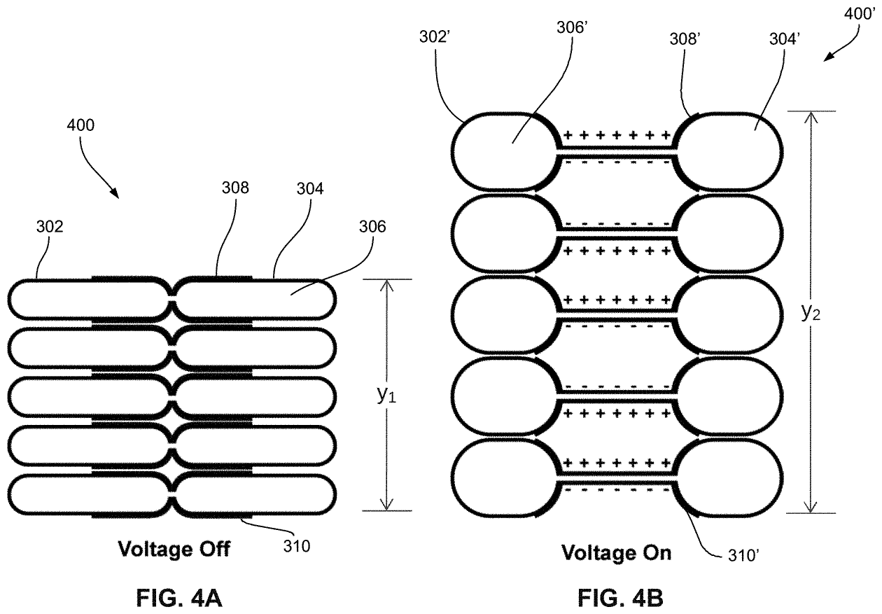

FIGS. 4A and 4B show multiple HASEL actuators 300 stacked on top of each other to create a system 400 of HASEL actuators. Stacking actuators in this manner increases the actuation stroke (i.e., the change in height represented by the expression y-y₀) and the actuation stroke is proportional to the number of HASEL actuators in the stack. The electrical potential of adjacent electrodes may be the same in order to prevent dielectric breakdown between actuators in the stack. FIG. 4A shows the actuator system 400 in an off-state having a height of y₁; FIG. 4B shows the actuator system 400′ in an on-state having a height of y₂. The difference between the on-state height and the off-state height (i.e., y₂-y₁) is the actuation stroke. As discussed above, the actuation stroke may be a function of an external load applied to the actuator system 400′ and/or a voltage applied to the system.

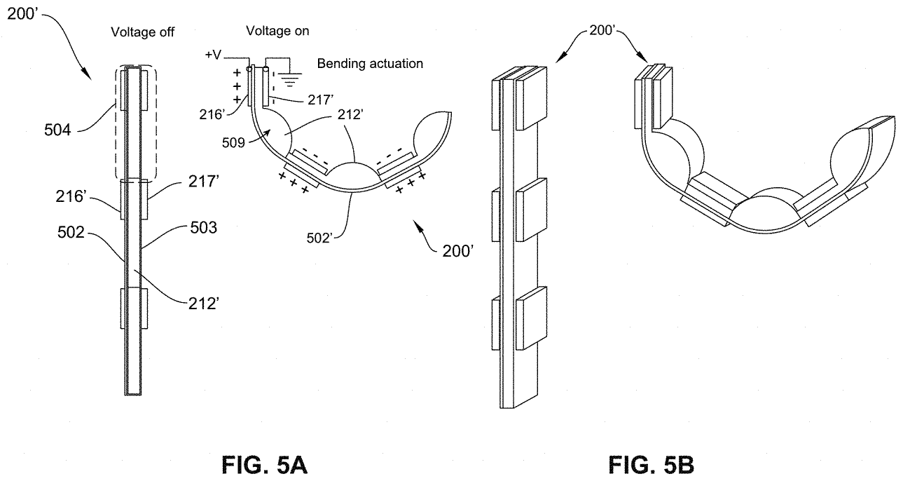

FIGS. 5A and 5B illustrate a particular type of contracting HASEL actuator 200′ for modes of actuation such as bending applications. These applications may be useful such as for the construction of soft grippers for handling delicate and irregular objects. These contracting HASEL actuators 200′ incorporate regions that have a greater bending stiffness relative to other regions to achieve such modes of actuation. This stiffening can be achieved through higher stiffness materials, semi-rigid or rigid materials coupled with soft joints, and/or in other suitable manners. The stiffened regions can be located along all or portions of the actuator shell to achieve various modes of actuation.

In FIG. 5A, the contracting-type actuator 200′ achieves bending modes of actuation by configuring a first portion 502 of the shell (e.g., a left or bottom side in FIG. 5A) to have a greater bending stiffness than a second portion 503 of the shell (e.g. a right or upper side in FIG. 5A). Thus, the pouch 509 of each unit 504 is generally surrounded by the first portion 502 of the shell on one side and the second portion 503 of the shell on the other side. When a voltage is applied, inhomogeneous deformation of the pouches 509 leads to preferential contraction on the right, and overall bending. FIG. 5B shows a perspective view, illustrating the deformation during actuation.

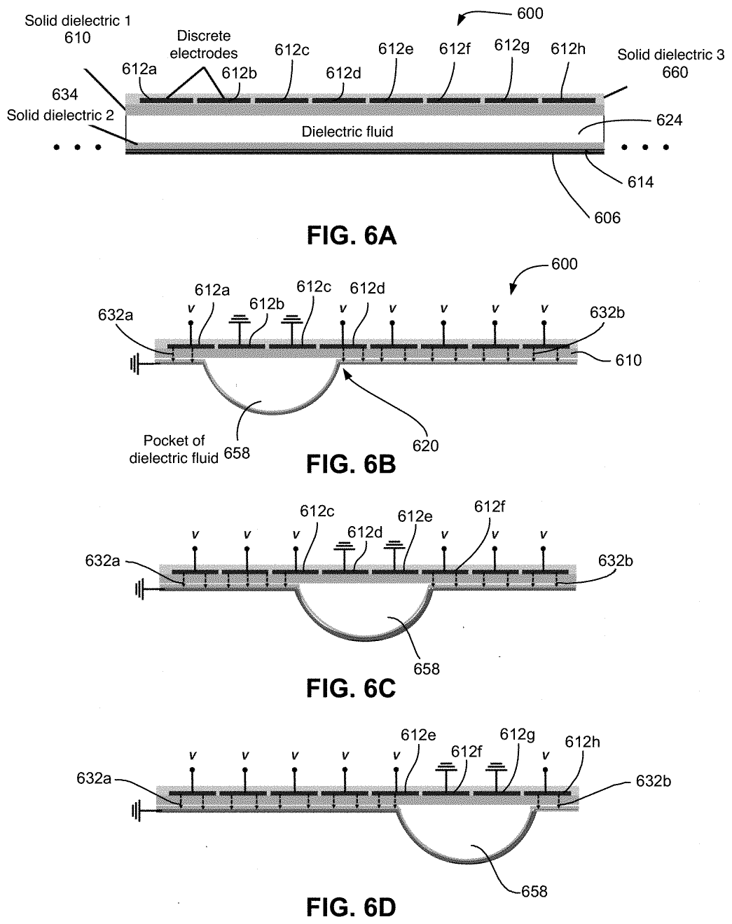

FIGS. 6A-6D illustrate an actuator that generates peristaltic motion 600. As shown in FIG. 6A, actuator 600 includes an outer wall 606 which may comprise a surface of a flexible electrode 614, as shown or may be a separate flexible wall component. The outer wall 606 is configured to interact with objects and move them along the surface of the outer wall in a peristaltic motion.

Moving objects along the actuator outer wall 606 may be accomplished by selectively actuating at least two of a plurality of distinct electrodes 612a-612h to form one or more dielectric fluid pockets 658 by selectively moving dielectric fluid volume 624. For example, referring to FIG. 6B, a pocket 658 of dielectric fluid is formed by applying voltage, V, to spaced apart or non-adjacent electrodes 612a and 612d. When the voltage is applied, first and second electric fields 632a, 632b are generated by the first dielectric 610 on which the electrodes are disposed. The electric fields interact with the flexible electrode 614, causing at least a first and second portion 618, 620 of the flexible electrode 614 to move toward the first dielectric 610 and displace dielectric fluid to form the pocket 658. Electrodes 612b, 612c between the energized electrodes 612a, 612d do not receive voltage in order to facilitate bending of the flexible electrode 614 away from the electrodes 612b, 612c to form the pocket 658. The first dielectric 610 may be a rigid or semi-rigid material such as biaxially oriented polyester film, biaxially oriented polypropylene, polyvinylidene fluoride terpolymer, and polyimide film. A second dielectric 634 formed from a flexible or stretchable material may be included between the dielectric fluid volume 624 and flexible electrode 614 as shown, but is not required in all embodiments.

Referring to FIG. 6C, an example of moving the pocket 658 is shown. To move the pocket from the location shown in FIG. 6B to the location shown in FIG. 6C, voltage V is applied to electrode 612b and 612c and voltage is withdrawn from electrodes 612d, 612e. As the flexible electrode 614 draws closer to the electrodes 612b, 612c, dielectric fluid is displaced toward the electrodes 612d, 612e which are not actively generating an electric field. Thus, by selectively applying voltage to spaced apart or non-adjacent distinct electrodes, the pocket 658 can move along a length of the actuator 600 and the pocket 658 could press against an object situated near the outer wall 606 to move that object along the length of the actuator.

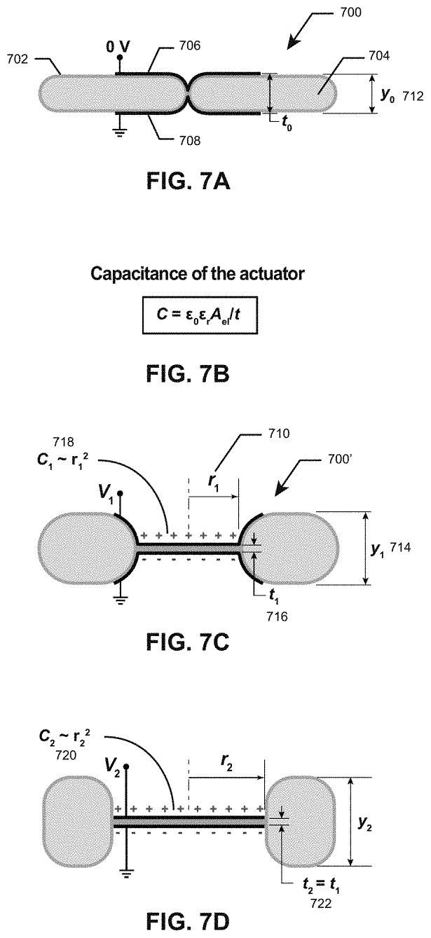

FIGS. 7A-7D illustrate changes in the fundamental capacitance of a HASEL actuator. FIG. 7A shows an expanding actuator 700 which includes a dielectric film 702, liquid dielectric 704, a first electrode 706 and a second electrode 708. As shown in FIG. 7B, the capacitance of the expanding actuator 700 depends on four variables:

C=ϵ₀ϵᵣA_{ϵl}/t [Eq. 2]

where ϵ₀ is the permittivity of free space (8.85×10⁻¹² F−m⁻¹), ϵᵣ is the relative permittivity of the material between the first and second electrodes 706, 708, A_{ϵl} is the area of the electrodes, and t is the distance between the first and second electrodes 706, 708.

FIG. 7C illustrates an expanding actuator 700′ with an applied voltage V₁ which has caused the electrodes to partially zip together and form a zipped electrode area with a radius of r₁ 710. The thickness of the actuator has increased from y₀ 712 to y₁ 714. Thickness, t₁ 716, between the electrodes in the zipped region is just due to the thickness of the film. Because the spacing between electrodes outside of the zipped region is large, the capacitance of that region can be ignored and capacitance of the actuator depends on the size of the zipped region. For the example illustrated in FIG. 7B, capacitance is proportional to the radius of the zipped area squared 718.

FIG. 7D illustrates that when voltage is increased from V₁ to V₂, the radius of the zipped region increases and the capacitance of the actuator increases accordingly 720. Because the thickness of the dielectric film is constant, the spacing between the electrodes is the same 722. For a given load and known applied voltage, it is possible to infer information about the actuator thickness based on a measured capacitance of the actuator.

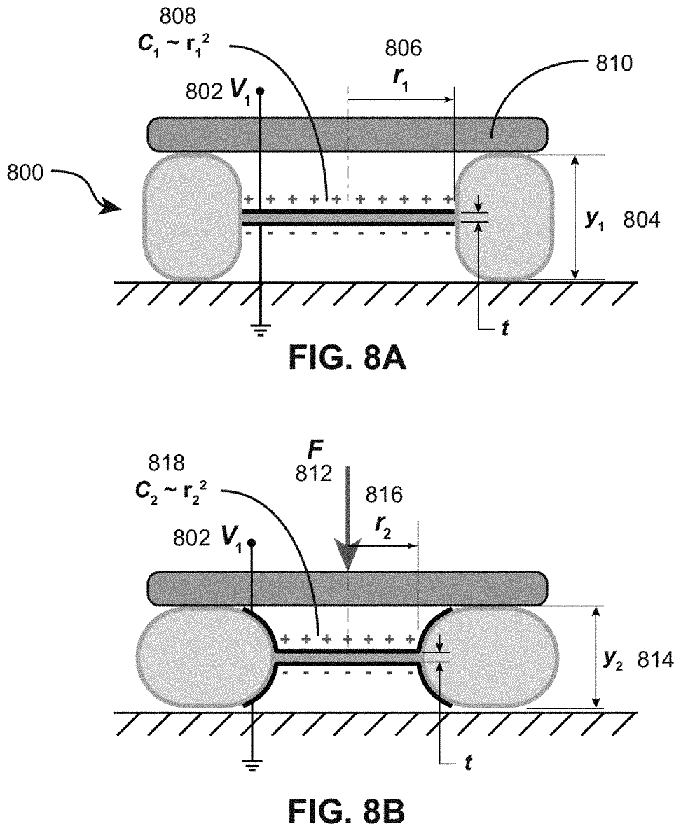

FIGS. 8A and 8B illustrate a sensor application of a HASEL actuator. In particular, FIG. 8A illustrates an expanding HASEL actuator 800 that has been activated by a voltage V₁ 802 and has a thickness of y₁ 804. The electrodes have zipped together to form a circular area with radius of r₁ 806 which influences the measured capacitance of the actuator C₁ 808. A rigid block 810 is placed on top of the actuator to distribute any applied loads.

In FIG. 8B, the voltage applied to the actuator is the same 802 and an external force F 812 has been applied to compress the actuator. This reduces the actuator thickness yz 814 and reduces the radius of the zipped region 816 which results in a decreased capacitance 818. Thus, monitoring capacitance for a known voltage can provide information about external loads applied to the actuator. For example, with a constant applied voltage a relative decrease in capacitance indicates that a new load was applied and an increase in capacitance would indicate that a load was removed. Because capacitance is a function of actuator displacement for a fixed voltage, the absolute value of force applied to the actuator can be inferred from the measured capacitance of the actuator.

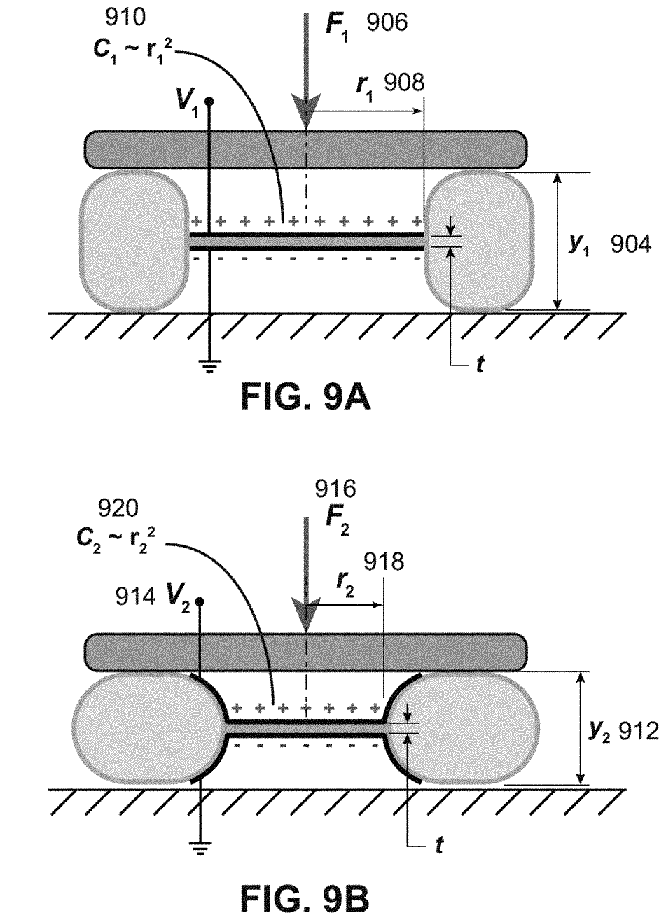

FIGS. 9A and 9B illustrate configurations of another sensor application of a HASEL actuator. FIG. 9A illustrates an expanding HASEL actuator 900 that has been activated by a voltage V₁ and has a thickness of y₁ 904. An external force F₁ 906 has been applied to the actuator. The electrodes have zipped together to form a circular area with radius of r₁ 908 which influences the measured capacitance of the actuator C₁ 910.

In FIG. 9B, the thickness of the actuator has been reduced to to y₂ 912. This reduction may be the result of voltage V₂ 914 being lower than V₁, force F₂ 916 being higher than F₁ 906 or a combination of both. The deceased thickness causes the zipped radius of the actuator to decrease and the zipped region now forms a circular area of radius r₂ 918. The resulting change in capacitance 920 can be used to infer the change in displacement or force.

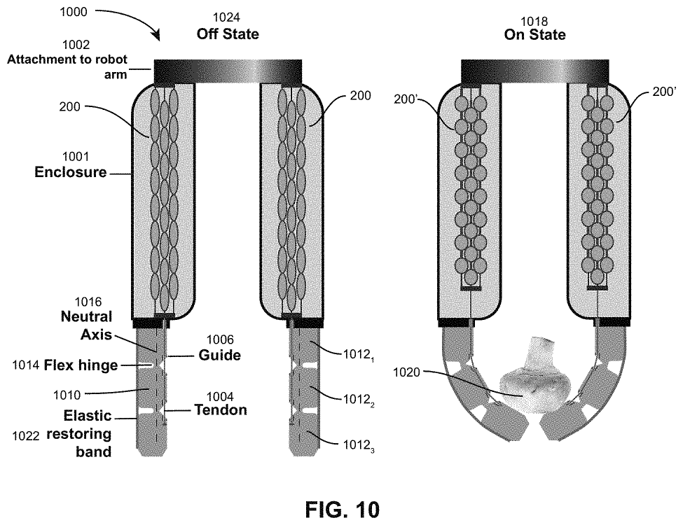

The following FIGS. 10-17 illustrate various systems of HASEL actuators designed specifically for gripping application. While previous disclosure has shown the potential use of HASEL actuators for gripping objects, the present disclosure provides examples of systems that have been designed and developed to meet the specific requirements of a variety of gripping and grasping applications. For example, grasping tasks require a large range of motion, grip size that can be adjustable during operation, and a range of force outputs. Additionally, the examples of the systems described herein are designed to effectively sense deformation, force, or a combination of both when an object is contacted or grasped.

FIG. 10 illustrates an off state and an on state of a gripper 1000 that is driven by a pair of contracting HASEL actuators, such as actuators 200 illustrated in FIG. 2, in accordance with an embodiment. The contracting actuators can be mounted within an enclosure 1001 to provide protection from impact or environment. One end of the contracting actuators 200 is attached to an adaptor that mounts to a robot arm or similar system 1002. The other end of the contracting actuator 200 is attached to a tendon 1004 which runs through guides 1006 embedded in a flexible finger 1010 which functions similarly to a human finger. The finger shown here has three segments 1012₁ 1012₂ and 1012₃ which are connected together with a flexible hinge or joint 1014. The tendon is anchored in the last segment of the finger 1012₃. Some configurations may include additional or fewer segments. The flexible hinge defines a neutral axis 1016 and each segment will rotate about an axis that is coincident and perpendicular to the neutral axis. When the contracting actuator 200′ is in the on-state 1018, the tendon is pulled in the direction of contraction which causes the finger segments to bend. This motion can be used to grasp various objects 1020. Varying voltage applied to the contracting actuator will change the amount of bending and the gripping force applied by the finger. An elastic restoring band 1022 helps the finger return to its initial position when the actuator is in the off-state 1024.

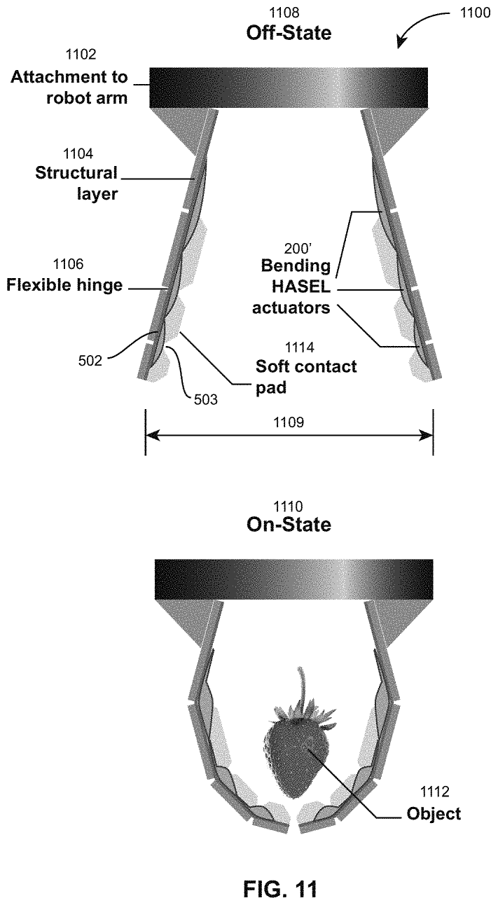

FIG. 11 illustrates an off-state and an on-state of a gripper 1100 that is constructed from a pair of contracting actuators that are configured to produce a bending motion, such as illustrated in FIGS. 5A and 5B, in accordance with an embodiment. The pair of bending actuators 200′ can be mounted to the end of a robotic arm or similar device 1102. A structural layer 1104 with flexible hinges 1106 may be bonded to the first portion 502 of the shell which has a greater bending stiffness than the second portion 503 of the shell. The flexible hinges 1106 may increase the stiffness of the structure and help the bending actuator return to its initial position when the actuator is in the off-state.

When the actuators are in an off-state 1108, the opening of the gripper 1109 may be fixed or adjustable. In the on-state 1110, the actuators and gripping structures bend towards each other and can be used to grasp objects 1112. The inside of the gripper may be fitted with soft contact pads 1114 to provide more friction and contact area with the object being grasped. Soft contact pads may be made, for example, from silicone rubber, foam, or elastic pouches filled with gas or fluid. The contact pads may be textured or coated with other materials to increase friction with an object. Finally, contact pads may include force and proximity sensors to detect contact and force with an object.

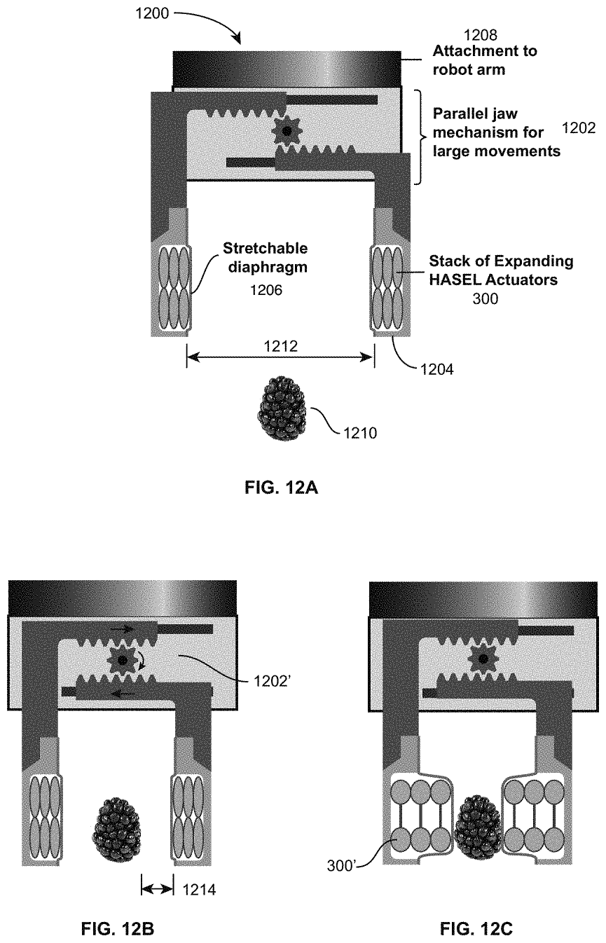

FIGS. 12A-12C illustrate an exemplary embodiment of a gripper 1200 that combines a motor-driven parallel jaw mechanism 1202 with expanding HASEL actuators, such as HASEL actuator 300 illustrated in FIGS. 3A and 3B, that are mounted on the ends of the gripper jaws 1204. A stretchable diaphragm 1206 covers the expanding actuators. This gripper assembly 1200 can be mounted to the end of a robot arm or similar system 1208.

Before getting into position to grip an object 1210, the opening of the parallel jaws 1212 may be much larger than the object 1210 and the expanding actuators may be in their off-state, as shown in FIG. 12A.

As shown in FIG. 12B, once the gripper 1200 is in position to grab an object 1210, the parallel jaws may close 1202′ so that the gap between the object and stretchable diaphragm is less than or equal to the achievable stroke of the expanding actuator 1214. FIG. 12C shows that the expanding actuators come into contact with the object 1210 once they are activated 300′. The voltage supplied to the actuators 300′ can be varied to increase or decrease the force applied to the object 1210.

The expanding actuators may be activated 300′ when the gripper opening is still much larger than the object 1210 and can remain in the on-state 300′ while the spacing on the parallel jaws is reduced. In this mode of operation, the expanding actuator 300′ can serve as a soft contact point for the object 1210. Once the expanding actuator 300′ deforms from contacting the object 1210, a change in capacitance of the actuator will indicate contact and can signal the parallel jaws to stop moving or to make smaller adjustments. Voltage applied to the expanding actuator can then be varied to adjust grip force.

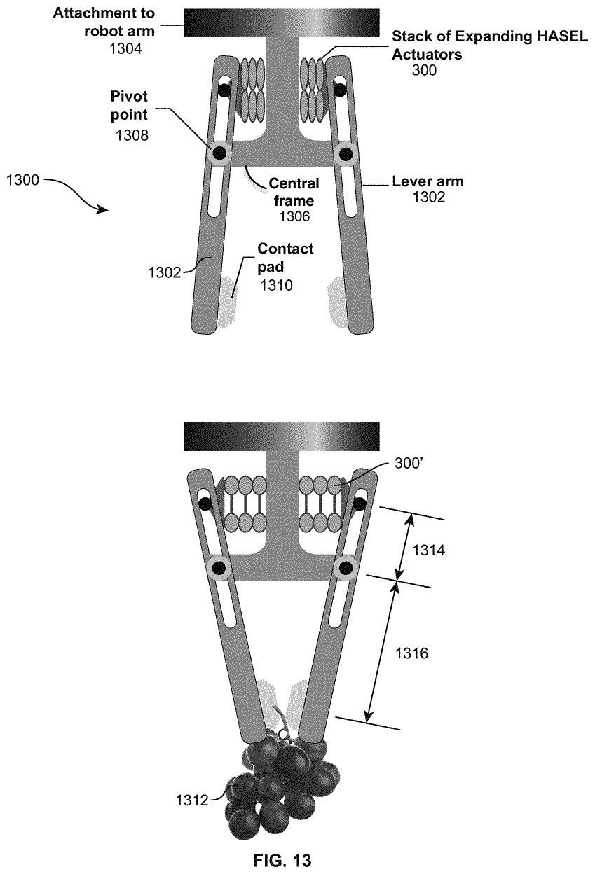

FIG. 13 illustrates two states of a gripper 1300 that includes two lever arms 1302 that are actuated using expanding HASEL actuators, such as HASEL actuators 300 illustrated in FIGS. 3A and 3B, in accordance with an embodiment. This gripper assembly 1300 can be mounted to the end of a robot arm or similar system 1304. The end of the lever 1302 that is closer to the end of the robot arm 1304 is in contact with a stack of expanding actuators 300. Both stacks of expanding actuators are mounted onto a central frame 1306. The pivot point 1308 of each lever is attached to the central frame 1306 as well. Contact pads 1310 are on the other ends of each lever arm and help provide good contact with objects 1312. In the on-state, the expanding actuators 300′ cause the lever arms to rotate about their respective pivot points to grasp an object 1312. Force and displacement at the contact pads 1310 can be adjusted by varying voltage applied to the expanding actuators 300′.

The ratio of the distance between the pivot point and expanding actuators 1314 and the distance between the contact pad and pivot point 1316 determines the mechanical advantage of the lever arm. For ratios less than 1, the force at the contact pad will be a fraction of the expanding actuator force but displacement will be higher. Conversely, for ratios greater than 1 the force at the contact pad will be higher than the expanding actuator but the displacement will be less.

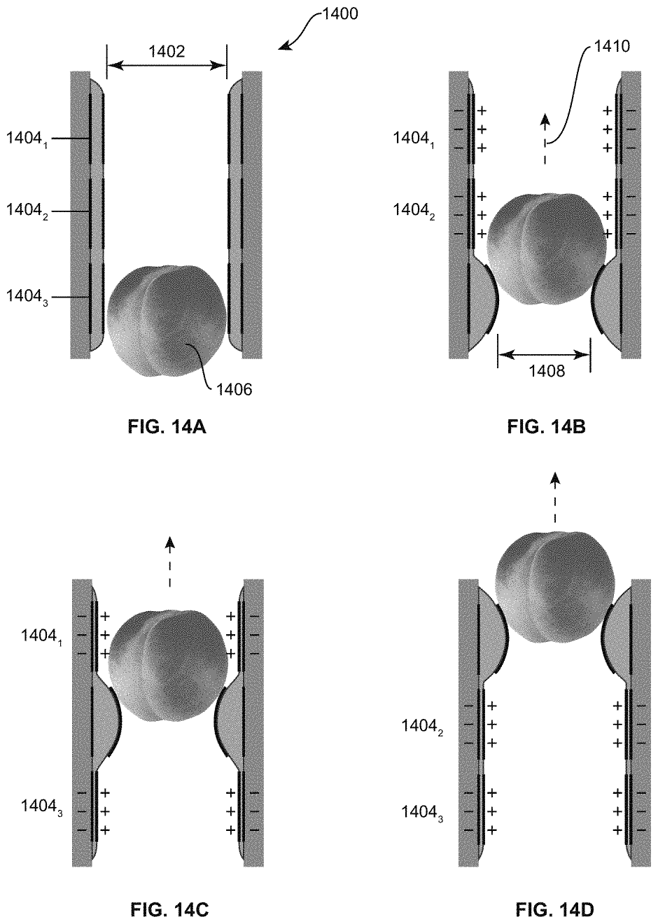

FIGS. 14A-14D illustrate a system for picking up objects 1400 including opposing peristaltic actuators, such as actuator 600 illustrated in FIGS. 6A-6D, in accordance with an embodiment. The spacing between the actuators can be adjustable 1402 to match the size of object 1406 that will be picked up. FIGS. 14A-14D show a system including three separate electrode pairs 1404₁, 1404₂, and 1404₃ which can be selectively activated with an applied voltage.

As shown in FIG. 14B, a pocket of liquid dielectric 658 forms in segments that are in an off-state 1404₃ when other segments are in an on-state 1404₁, 1404₂. The pocket of liquid dielectric 658 reduces the opening between the outer walls of the actuators 1408 and can move the object 1406 along the length of the actuator 1410. As shown in FIGS. 14C and 14D, activating segments in a sequence will move the pocket of dielectric fluid and the object further along the length of the actuator.

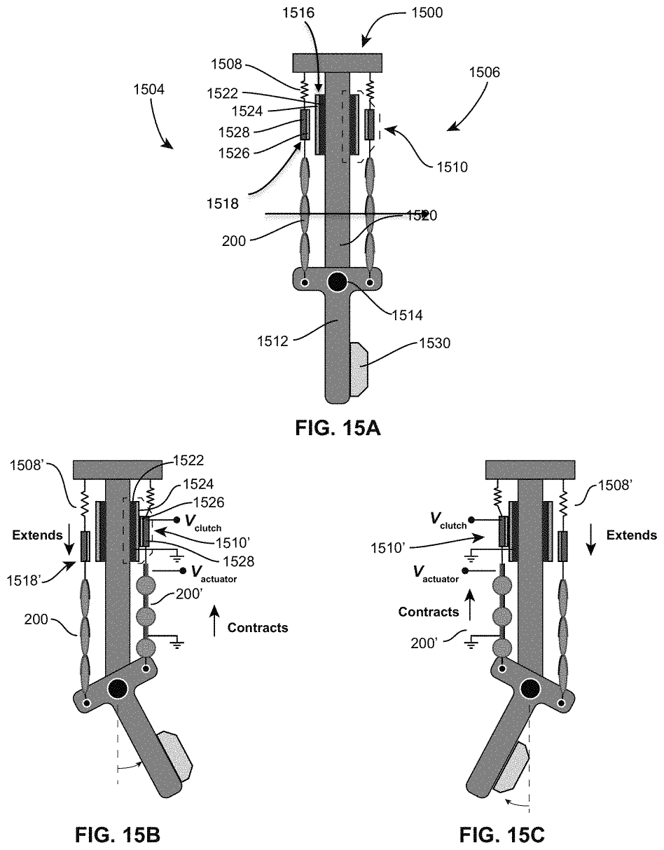

FIGS. 15A-15C illustrate a system 1500 for antagonist rotation of a linkage 1502, in accordance with an embodiment. In this case, the antagonist pair including a first side 1504 and second side 1506 which use identical components. Each side 1504, 1506 includes a spring element 1508, an electrostatic clutch 1510, and a contracting HASEL actuator, such as HASEL actuator 200 of FIG. 2. The spring element 1508 is anchored to a fixed point while the contracting actuator 200 end is anchored to a link 1512 that rotates about a pivot point 1514.

FIG. 15A shows the components of the electrostatic clutch, which includes a fixed side 1516 and a sliding side 1518. The fixed side 1516, which in this case is mounted to a fixed link 1520, includes of a first electrode 1522 that is covered with a first insulating layer 1524. The sliding side 1518 includes a second insulating layer 1526 which is adjacent to the first insulating layer 1524 and a second electrode 1528 on the opposite side of the second insulating layer 1526. The sliding side 1518 is connected on one end to the spring element 1508 and on the other end to a contracting actuator, such as HASEL actuator 200 of FIG. 2. In certain embodiments, there may be an air gap between the first insulating layer 1524 and the second insulating layer 1526 which allows the sliding side 1518 to freely move in a direction parallel to the surface of the fixed side 1516.

In FIG. 15B, the second side 1506 is in an on-state while the first side 1504 is in an off-state. In the on-state, the electrostatic clutch 1510′ has a voltage potential applied across the first and second electrodes 1522, 1528. This applied voltage causes the first and second insulating layers 1524, 1526 to come in contact with each other with some force which prevents the sliding side 1518 from moving relative to the fixed side 1516. This action can be referred to as “engaging” the electrostatic clutch. When the clutch is engaged 1510′ the spring element 1508 does not support any load. Also, the load applied by the contracting actuator 200′, which is also in an on-state, is supported by the clutch. Because one end is supported by the clutch, the contraction of the actuator 200′ causes the lower link 1512 to pivot in a counter-clockwise direction. The first side 1504 of the antagonist pair is in an off-state where the contracting actuator 200 is not activated and the sliding side 1518′ moves relative to the fixed side of the clutch. The spring element on the first side 1508′ is then able to extend as the lower linkage 1512 rotates in a counter-clockwise direction.

In FIG. 15C, the first side 1504 is in an on-state while the second side 1506 is in an off-state. This results in clockwise rotation of the lower linkage 1512.

This type of system can be applied to a variety of applications such as antagonist pairs for robotic arms, legs, or other functional devices, such as those illustrated elsewhere in the present disclosure. In this case, the antagonist pair may be used as the articulated finger of a gripper and includes a contact pad 1530 on the rotating link 1512. While FIGS. 15A-15C show a system with two links and one pivot point, additional pivot points and links as well as multiple antagonistic pairs of actuators, clutches, and springs can be implemented to created systems with multiple degrees of freedom.

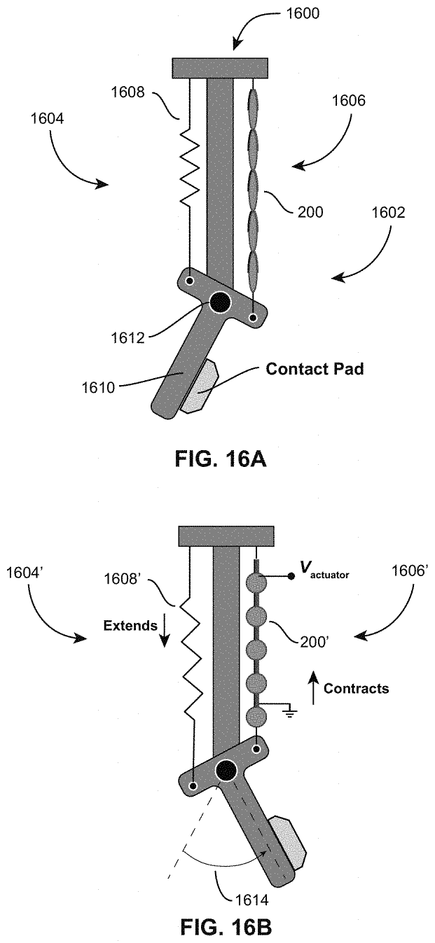

FIGS. 16A and 16B illustrate another system for antagonist rotation 1600 of a linkage 1602, in accordance with an embodiment. In this case, the antagonist pair includes of a first side 1604 including a spring 1608 and a second side 1606 including a contrating HASEL actuator, such as HASEL actuator 200 of FIG. 2. One end of the spring 1608 is fixed while the other is connected to the left side of a link 1610 that can rotate about a pivot point 1612. One end of the contracting actuator is fixed while the other is connected to the right side of the rotatable link 1610.

As shown in FIG. 16B, when the contracting actuator is in the on-state 200′, the link 1610 rotates in a counter-clockwise direction 1614 and the spring simultaneously extends 1608′. When voltage is removed from the actuator 200, the spring pulls the rotating link in a clock-wise direction to return the linkage to its original position shown in FIG. 16A.

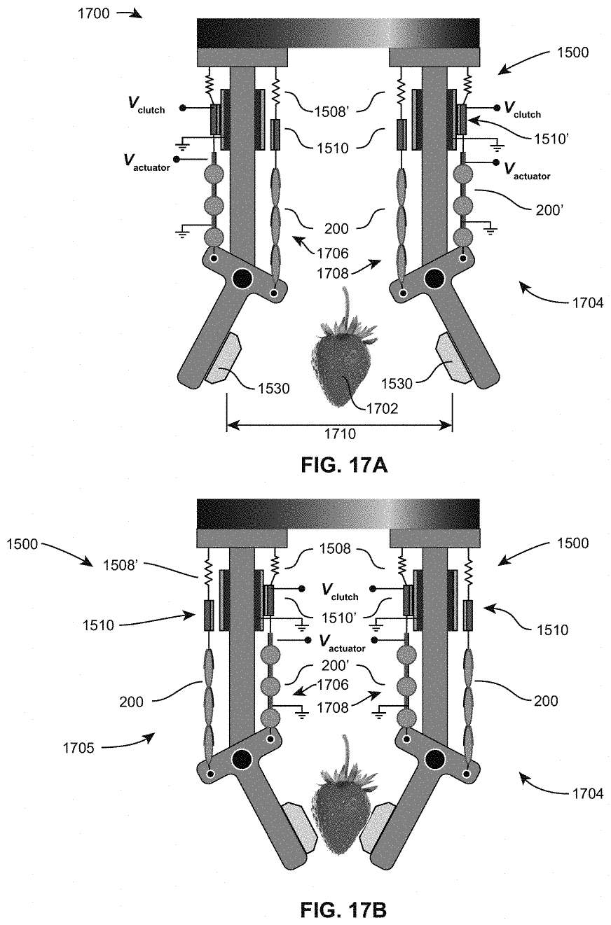

FIGS. 17A and 17B illustrate a gripping system 1700 including two sets of antagonist pairs 1500 which can be used to pick and place various objects 1702, in accordance with an embodiment. In FIG. 17A, the outer sides (far left and far right) 1704, 1705 are in an on-state where the electrostatic clutch is engaged 1510′ and the contracting actuators are in an on-state 200′. The inner sides 1706, 1708 are in an off-state where the contracting actuator is off 200, the clutch is not engaged 1510 and the springs are extended 1508′. The resulting spacing between the contact pads 1710 is much larger than object 1702.

FIG. 17B shows that by activating the inner sides 1706, 1708 of the antagonistic pairs and switching the outer pairs 1704, 1705 to an off-state, the gap between the contact pads close and gripper comes into contact with the object 1702. The grip force can be varied by the voltage applied to the actuator.

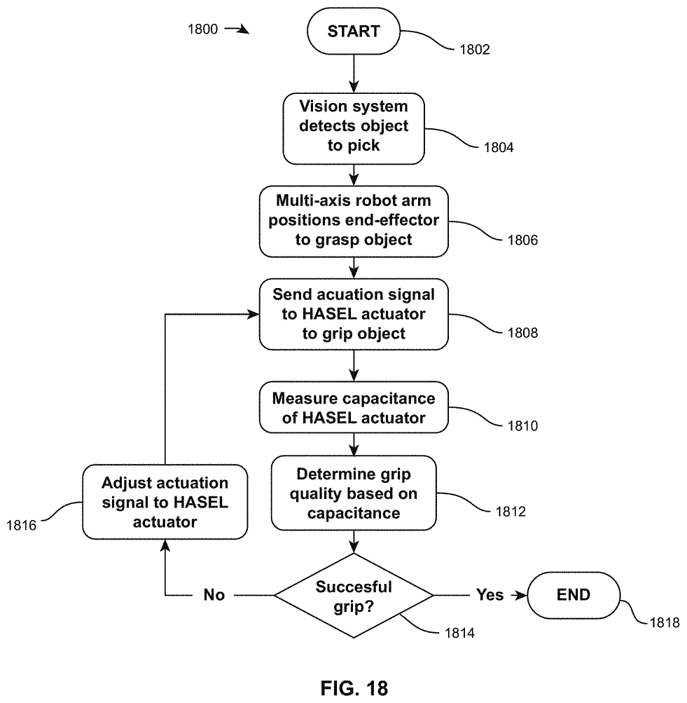

FIG. 18 illustrates a process flow 1800, in accordance with an embodiment, for control of a gripper powered by HASEL actuators as it grips an object starting at a start step 1802. A vision system is used to identify an object to be picked in a step 1804 and a multi-axis robot arm positions the end-effector to grip an object in a step 1806. An actuation signal is sent to the HASEL actuator to grip the object in a step 1808 and the capacitance of the actuator is measured or monitored in a step 1810 to determine quality of the grip in a step 1812. Based on the change in capacitance and/or absolute value of capacitance, a determination is made to assess if the grip was successful in a step 1812. A decision 1814 determines whether the grip is sufficient to continue moving the gripper arm. If decision 1814 determines YES the grip is successful, then process flow 1800 is terminated in an end step 1818, and the robot arm continues with subsequent steps in the processing flow (not shown). If decision 1814 determines NO the grip is not successful, the HASEL actuator signal will be adjusted accordingly in a step 1816.

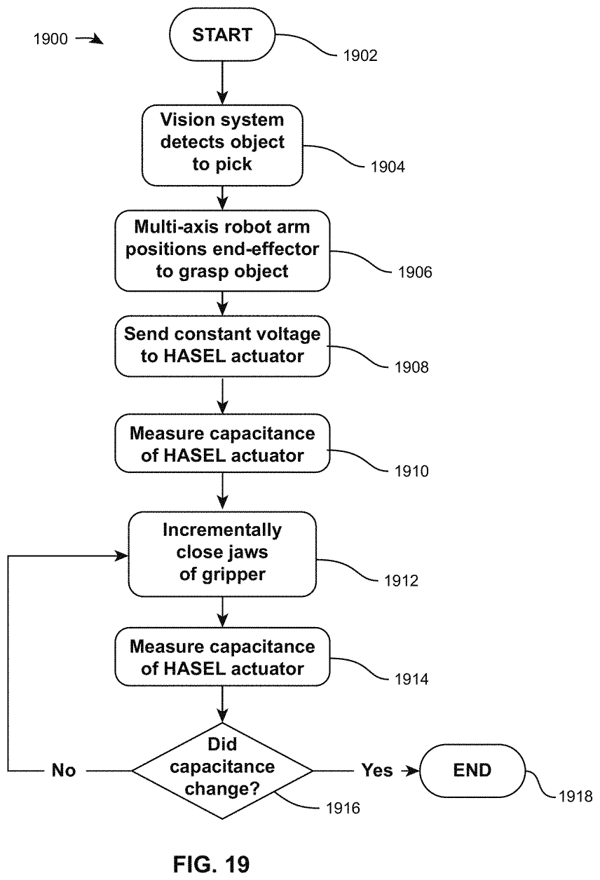

FIG. 19 illustrates a process flow 1900, in accordance with an embodiment, for controlling a parallel jaw gripper with HASEL actuators mounted to the jaws of the gripper, similar to system 1200, starting at a start step 1902. A vision system may be used to identify an object to be picked in a step 1904 and a multi-axis robot arm positions the end-effector to grip an object in a step 1906. Before moving the jaws, the HASEL actuator is activated by a constant voltage signal in a step 1908 and the capacitance of the actuator is monitored in a step 1910. As the jaws are closed incrementally in a step 1912, the capacitance of the actuator is measured periodically or continuously in a step 1914 to detect any change in capacitance which would indicate contact with an object. The jaws continue to close until a sufficient change in capacitance is detected in determination 1916 and, if a sufficient change in capacitance (e.g., as preset by the operator) has been detected, then the process ends in an end step 1918. If the measured capacitance change is below a threshold amount, then process flow 1900 returns to 1912 to continue to close the jaws of the gripper. That is, as the HASEL actuator is used to control the gripping action, the capacitance of the HASEL actuator may be simultaneously monitored as feedback for determining contact with the object to be picked up with the gripper. This ability to simultaneously affect the gripping action and providing feedback to quantify the amount of gripping force placed on the object to be gripped is advantageous, particularly for the gripping of fragile, compressible, or heavy objects, for example.

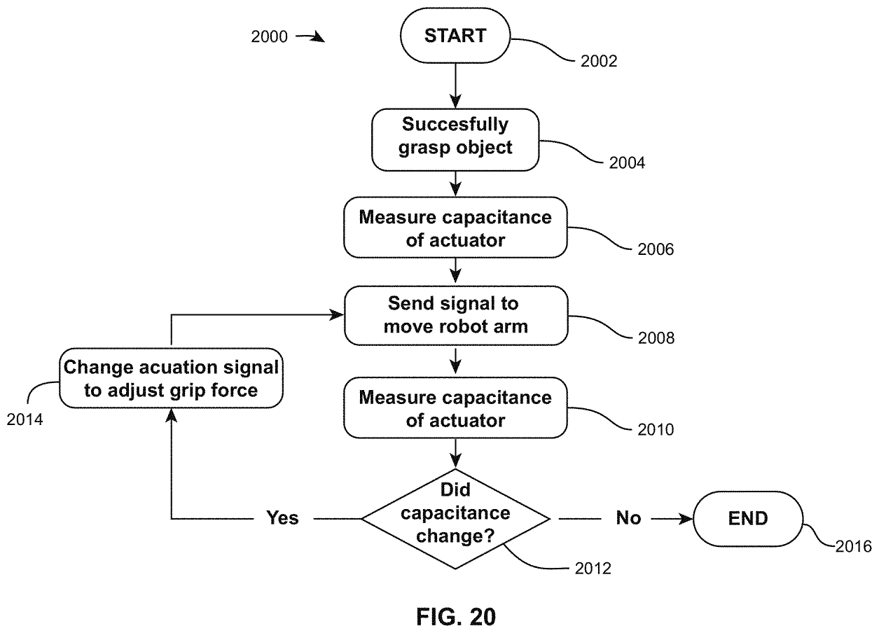

FIG. 20 illustrates a process flow 2000, in accordance with an embodiment, for monitoring a gripper powered by a HASEL actuator during movement starting at a start step 2002. After an object is successfully grasped in a step 2004, capacitance of the HASEL actuator is monitored in a step 2006 and a signal is sent to move the robot arm in a step 2008. During movement, the capacitance of the actuator is monitored in a step 2010. During movement, slipping of the object from the gripper or any change in the grip could result in a change of capacitance and a determination 2012 is made to assess whether the capacitance has measurably changed from an acceptable range. If determination 2012 yields the capacitance has changed, then the actuation signal will be changed in a step 2014 to adjust the grip force accordingly. If the measured capacitance in step 2010 remains within an acceptable range, then the robot arm continues to move while, optionally, the capacitance is monitored, until the object reaches its destination and the process ends in an end step 2016.

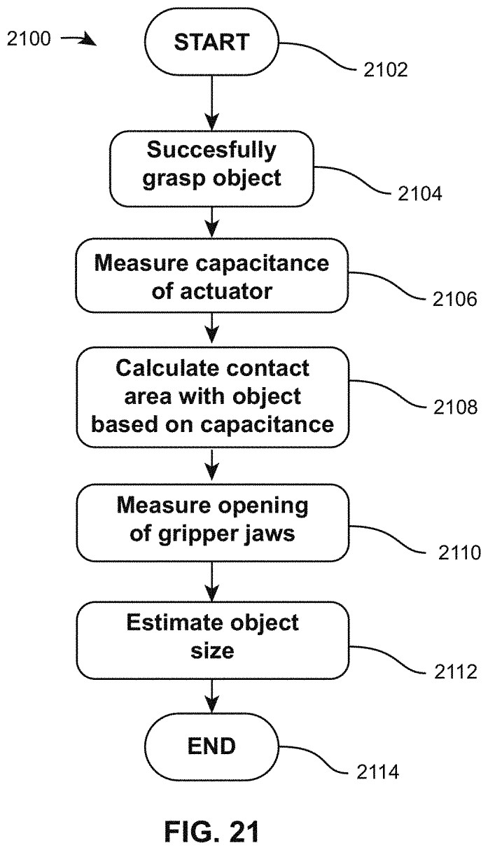

FIG. 21 illustrates a process flow 2100, in accordance with an embodiment, for estimating the size of an object using a gripper powered by a HASEL actuator starting at a start step 2102. After an object is successfully grasped in a step 2104, capacitance of the HASEL actuator is measured in a step 2106 and the contact area of the actuator and object is inferred or calculated from the measured capacitance in a step 2108. The spacing between the gripper jaws is measured as well, either based on actuator position or external sensors, in a step 2110. Based on the contact area and spacing, the object size is estimated in a step 2112 and the process ends 2114. That is, gripper systems based on HASEL actuators may be used to grip an object, assess the gripping efficiency (e.g., as discussed above with respect to FIG. 20), and to even estimate the size of the object.

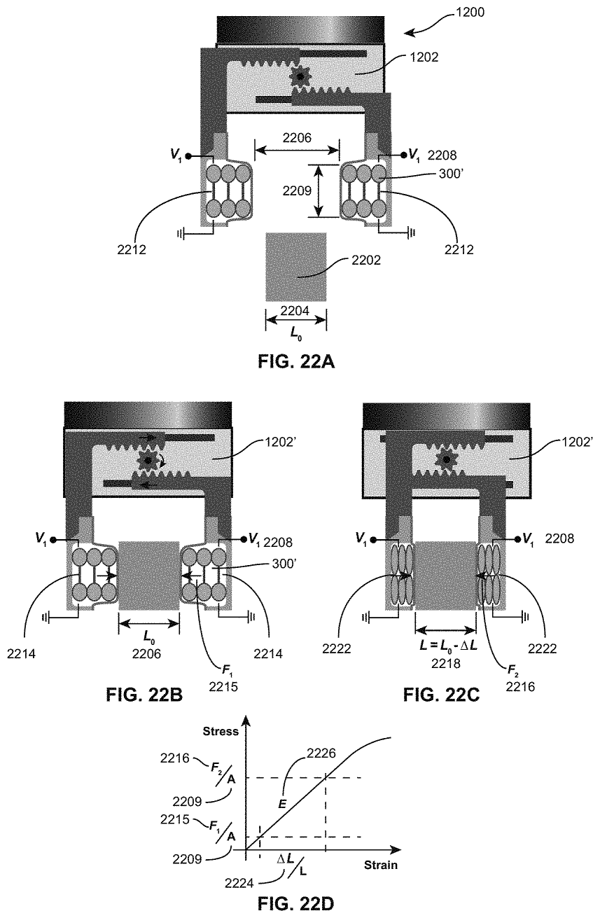

FIGS. 22A-22D illustrate a method of operating a parallel jaw gripper 1200 with HASEL actuators 300, such as shown in FIGS. 12A-12C, to estimate the modulus of elasticity of an object. As shown in FIG. 22A, gripper 1200 includes a parallel jaw mechanism 1202 with HASEL actuators mounted to the ends of the parallel jaws 300. An object to be grasped 2202 has an initial length 2204. Before grasping the object, the HASEL actuators are supplied a DC voltage 2208 causing them to expand and have a constant area 2209 for contacting the object. The opening of the gripper is adjusted 2206 to be larger than the object length 2204. Capacitance of the actuator 300′ in the on-state is measured 2212. The gripper then moves to contact the object and the parallel jaws close 1202′. The expanding actuators 300′ first contact the object when the opening is equal to the object length 2206 and the measured capacitance of the actuator 2214 changes slightly to indicate contact with an object. Based on the measured capacitance, the contact force 2215 can be inferred. As shown in FIG. 22C, with the applied voltage constant 2208, the parallel jaws continue to close. The force applied to the object 2216 increases causing the object to compress in length 2218. Simultaneously, the capacitance of the HASEL actuators changes 2222. Based on the measured capacitance 2222 and applied voltage 2208, the change in length of the object is determined 2218. FIG. 22D shows that the measured force at each state, change in length between states 2224, and contact area 2209 can be used to infer the elastic modulus 2226 of an object. This process can be useful for gripping applications that require knowledge of the material properties. Examples include but are not limited to determining ripeness of fruits and vegetables, identifying materials based on their modulus, or inferring temperature of an object.

This disclosure has shown several examples of HASEL actuator systems for gripping applications. The number of actuators shown in a given figure can be modified to achieve more force, stroke, or combination of both. For example, FIG. 15 shows an antagonist pair where each side includes a single contracting actuator that includes three pouches. The system may include stacks of actuators, more pouches per actuator, and spacers between the pouches to achieve more force and stroke at the gripper, in some embodiments. FIGS. 12 and 22A-22D show systems that combine a motor driven system with a system of HASEL actuators. The motor driven system provides another degree of freedom which could be added to any of the other systems shown in this disclosure.

As described above, FIGS. 10-17 illustrate several systems of HASEL actuators tailored for a variety of gripping applications.

For example, FIG. 10 shows a system that couples contracting HASEL actuators to a cable or tendon driven system. Activating the actuators pulls on the cable which causes the bending of flexible finger. This system resembles the structure and function of a human finger. Multiple fingers or degrees of freedom can be combined to create a gripper or robotic hand for grasping objects.

As another example, FIG. 11 shows a system that includes bending HASEL actuators integrated into a structure for gripping objects. Soft contact pads mounted to the gripper structure aid in gripping objects. This system can be combined with another mechanism to adjust the opening of the grippers.

As a further example, FIGS. 12A-12C show expanding HASEL actuators combined with a motor-driven parallel jaw mechanism. Parallel jaw grippers are a common type of gripper in robotics and industrial applications. In this case, expanding HASEL actuators are mounted to the jaws. In this system, the motion of the parallel jaw can provide large displacement while the expanding HASEL actuators can provide small movements and/or serve as a soft contact pad and sensor with actively tunable stiffness.

As still another example, FIG. 13 shows a gripper where expanding HASEL actuators are combined with a lever arm. The opposite end of the lever arm can be used to grasp objects. A contact pad on the end of the lever arm can be a soft material for passive compliance. This contact pad could also be another expanding actuator or include a sensor that detects contact and force. The pivot point of the lever arm can be adjustable to tune the range of motion and force at the end of the gripper.

Further, FIGS. 14A-14D show a system of HASEL actuators which produces peristaltic motion. While such peristaltic motion is typically used for pumping, here it may be used to transport objects along the length of the peristaltic system. The figures shows a 2D representation of a peristaltic system including three electrode segments, but this system could be cylindrical and the number of electrode segments may be much more than three. The opening of the cylinder or jaws may be adjustable either manually or with a motor-driven system.

Additionally, FIGS. 15A-17B illustrate the use of antagonist pairs including HASEL actuators and other elements such as springs and electrostatic clutches. The antagonist pairs are applied to grippers and allow for movement of the end of the gripper in two directions, such as clockwise and counterclockwise rotation shown in FIGS. 15B and 15C. When applied to a gripper, as shown, this system can allow for gripping a wide range of objects. These systems can also be mounted to a parallel jaw mechanism to increase the range of motion and allow for gripping of various object sizes.

The systems described above are unique in the combination of HASEL actuators with other mechanisms for the purpose of gripping objects. The systems take advantage of the electrical control, self-sensing ability, and compliance of HASEL actuators which is useful for gripping objects that are delicate, that vary shape, and vary in size. Additionally, the HASEL actuator-based gripper systems may also be used to ascertain characteristics of the objects to be gripped, such as elasticity, size, and effectiveness of the gripping force provided in manipulating the object.

FIGS. 18-22D describe and illustrate processes and methods for using these systems for gripping objects, detecting quality of a grip including during movement, and inferring information about objects that have been gripped based on the capacitance of the HASEL actuators used in the system.

It is noted that the specific configuration of the HASEL actuator, such as the size, thickness, pouch shape, electrode shape, filler material, amount of filler material used within each pouch, and use of spacer materials between adjacent pouches, may be tailored for the particular application for which the HASEL actuator is used. Some options are described in the aforementioned related applications, as well as more recently filed patent applications such as U.S. Provisional Patent Application Ser. No. 63/398,476, filed Aug. 18, 2022 and entitled “Performance Improvements for Soft Hydraulic Electrostatic Zipping Actuators,” and U.S. Provisional Patent Application Ser. No. 63/400,329, filed Aug. 23, 2022 and entitled “Miniature Soft Hydraulic Electrostatic Zipping Actuators,” all of which applications are incorporated herein by reference in their entirety.

Accordingly, although the present disclosure has been provided in accordance with the implementations shown, one of ordinary skill in the art will readily recognize that there could be variations to the embodiments and those variations would be within the scope of the present disclosure. Therefore, many modifications may be made by one of ordinary skill in the art without departing from the scope of the appended claims. Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween.

1-6. (canceled)

7. A system for grasping an object, the system comprising:
first and second actuators; and
first and second structures, the first structure being mechanically connected with the first actuator and the second structure being mechanically connected with the second actuator,
wherein the first and second structures is configured for cooperating with each other such that, when the first and second actuators are activated, the first and second structure grasp the object therebetween,
wherein each one of the first and second actuators includes
a compliant shell defining an enclosed cavity,
a dielectric fluid disposed within the enclosed cavity,
a first electrode disposed on a first side of the compliant shell, and
a second electrode disposed on a second, opposing side of the compliant shell, and
wherein each one of the first and second actuators is activatable by application of a voltage on one of the first and second electrodes such that an electrostatic force between the first and second electrodes draws the first and second electrodes toward each other to displace the dielectric fluid within the enclosed cavity.

8. The system of claim 7, further comprising a robotic arm, the robotic arm being configured for connecting with at least one of the first and second actuators and the first and second structures.

9. The system of claim 7, wherein the first and second structures include at least one of: 1) a flexible finger; 2) a structural layer with flexible hinges; 3) a gripper jaw; and 4) a lever arm.

10. The system of claim 9,
wherein each one of the first and second structures includes a flexible finger,
wherein the flexible finger includes segments, each one of the segments being connected to each other one of the segments with a flexible hinge,
wherein the flexible finger further includes a tendon passing through the segments, a proximal end of the tendon being connected with one of the first and second actuators and a distal end of the tendon being anchored in one of the segments farthest from the one of the first and second actuators onto which the tendon is connected, and
wherein, when the first actuator is activated, the flexible finger of the first structure is moved from an initial position to a bent position.

11. The system of claim 10, the flexible finger further including an elastic restoring band being configured for restoring the flexible finger of the first structure from the bent position to the initial position, when the first actuator is inactivated.

12. The system of claim 10,
wherein, when the second actuator is activated, the flexible finger of the second structure is moved from an initial position to a bent position, and
wherein the bent position of the flexible finger of the first structure and the bent position of the flexible finger of the second structure are turned toward each other so as to pick up the object therebetween when the first and second actuators are activated.

13. The system of claim 9,
wherein each one of the first and second structures include a structural layer with flexible hinges,
wherein the first actuator is configured to cooperate with the first structure to bend the flexible hinges of the first structure when the first actuator is activated, and
wherein the second actuator is configured to cooperate with the second structure to bend the flexible hinges of the second structure when the second actuator is activated.

14. The system of claim 13, further comprising contact pads attached to the first and second structures for providing additional friction and contact area with the object being grasped.

15. The system of claim 14, wherein the contact pads include one of a texture and a coating for increasing friction with the object being grasped.

16. The system of claim 9, wherein each one of the first and second structures includes a stretchable diaphragm surrounding the first and second actuators, respectively, and
wherein, when activated, the first and second actuators are configured to expand the stretchable diaphragm to grasp the object therethrough.

17. The system of claim 16, further comprising a parallel jaw mechanism connected with the first and second structures for providing a larger movement between the first and second structures than otherwise would be possible with the first and second actuators alone.

18. The system of claim 17,
wherein the parallel jaw mechanism is configured to reduce a spacing between the first and second structures such that a gap between the object and the stretchable diaphragm is within an achievable stroke of the first and second actuators, and
wherein an activation voltage provided to the first and second actuators may be varied to adjust a grip force applied to the object when the first and second actuators are activated.

19. The system of claim 9,
wherein each one of the first and second structures includes a lever arm configured for rotation about a pivot point attached to a central frame,
wherein the first actuator is configured for rotating the lever arm in the first structure when activated,
wherein the second actuator is configured for rotating the lever arm in the second structure when activated, the second structure being configured for cooperating with the first structure for gripping the object therebetween.

20. The system of claim 19, further comprising a contact pad attached to each one of the lever arms in the first and second structures.

21. A system for grasping an object, the system comprising:
first and second actuators, each one of the first and second actuators including
a compliant shell defining an enclosed cavity,
a dielectric fluid disposed within the enclosed cavity,
a first pair of electrodes defining a first segment, the first pair of electrodes including a first electrode disposed on a first side of the compliant shell and a second electrode disposed on a second, opposing side of the compliant shell, the first segment being activatable by application of a first voltage to one of the first and second electrodes such that an electrostatic force between the first pair of electrodes draws the first pair of electrodes toward each other to displace the dielectric fluid within the first segment,
a second pair of electrodes defining a second segment, the second pair of electrodes including a third electrode disposed on a first side of the compliant shell and a fourth electrode disposed on a second, opposing side of the compliant shell, the second segment being activatable by application of a second voltage to one of the third and fourth electrodes such that an electrostatic force between the second pair of electrodes draws the second pair of electrodes toward each other to displace the dielectric fluid within the second segment, and
a support structure fixedly supporting the first and third electrodes to prevent movement of the first side of the compliant shell upon activation of at least one of the first and second segments,
wherein the first and second actuators are configured for cooperating with each other to grasp the object, and
wherein the first and second actuators are configured for moving the object peristaltically along the first and second actuators by coordinated activation of the first and second segments of the first and second actuators.

22. A method for operating a system for grasping an object, the method comprising:
providing a parallel jaw gripper system including
first and second actuators, and
first and second structures, the first structure being mechanically connected with the first actuator and the second structure being mechanically connected with the second actuator,
the first and second structures being configured for cooperating with each other such that, when the first and second actuators are activated, the first and second structure grasp the object therebetween, and
a parallel jaw mechanism connected with the first and second structures for providing a larger movement between the first and second structures than otherwise would be possible with the first and second actuators alone,
wherein each one of the first and second actuators including
a compliant shell defining an enclosed cavity,
a dielectric fluid disposed within the enclosed cavity,
a first electrode disposed on a first side of the compliant shell, and
a second electrode disposed on a second, opposing side of the compliant shell, and
wherein each one of the first and second structures includes a stretchable diaphragm surrounding the first and second actuators, respectively;
adjusting a distance between the first and second structures such that a gap between the object and the stretchable diaphragm is within an achievable stroke of the first and second actuators; and
applying a voltage to one of the first and second electrodes such that an electrostatic force between the first and second electrodes draws the first and second electrodes toward each other to displace the dielectric fluid within the enclosed cavity and expand the stretchable diaphragm to grasp the object therethrough.

23. The method of claim 22, further comprising:
adjusting a grip force applied to the object by varying an activation voltage provided to the first and second actuators while the first and second actuators are activated.

24. The method of claim 22, further comprising:
after applying the voltage to one of the first and second electrodes and prior to grasping the object, measuring a capacitance of at least one of the first and second actuators;
monitoring the capacitance of the at least one of the first and second actuators; and
calculating a contact force used in gripping the object based on variation in the capacitance so monitored.

25. The method of claim 24, further comprising:
monitoring change in a length of the object so grasped;
measuring a contact area onto which each one of the first and second actuators makes contact with the object so grasped; and
calculating an elastic modulus of the object based on the contact force so calculated, the change in length of the object, and the contact area so measured.
